(19) United States
(12) Patent Application Publication
(10) Pub. No.: US 2026/0010214 A1
(43) Pub. Date: Jan. 8, 2026

(54) SEMICONDUCTOR SYSTEM AND METHOD OF CONTROLLING RESET OPERATION CLOCK THEREOF

(71) Applicant: ITDA SEMICONDUCTOR CO., LTD., Hwaseong-si (KR)

(72) Inventors: Ahchan KIM, Hwaseong-si (KR); Hoyeon JEON, Seongnam-si (KR); Ingyu KIM, Hwaseong-si (KR)

(73) Assignee: ITDA SEMICONDUCTOR CO., LTD., Hwaseong-si (KR)

(21) Appl. No.: 19/255,100

(22) Filed: Jun. 30, 2025

(30) Foreign Application Priority Data
Jul. 2, 2024 (KR) 10-2024-0086592
Jul. 22, 2024 (KR) 10-2024-0096476

(51) Int. Cl. G06F 1/24; G06F 1/08

(52) U.S. Cl. CPC G06F 1/24; G06F 1/08

(57) ABSTRACT

Disclosed are a semiconductor system and a method of controlling a reset operation clock of the semiconductor system for easily determining a reset timing by inputting a reference clock slower than a function clock to a clock operation unit by a clock multiplexer during a reset operation or reset release operation. The semiconductor system includes a clock management unit configured to operate according to a function clock to generate and output an output function clock for an operation of the semiconductor system, and a power management unit configured to perform power management of the semiconductor system including a reset operation or a reset release operation. The clock management unit includes a clock operation unit configured to operate according to the function clock in an operation mode to generate and output the output function clock, and a clock multiplexer configured to select different input clocks to be input to the clock operation unit in the operation mode and a reset mode and output the input clocks to the clock operation unit.

### STATEMENT REGARDING GOVERNMENT SPONSORED RESEARCH OR DEVELOPMENT

This work was supported by Ministry of SMEs and Startups grant funded by Korea Technology and Information Promotion Agency for SMEs (TIPA). (Project Unique Number: 1425182152, Project Number: RS-2023-00302523, Research Program Name: Startup Growth Technology Development (R&D), Research Project Title: Low-Code Based Low-Power Semiconductor Solution, Executing Organization: ITDA Semiconductor, Research Period: Jul. 1, 2023-Jun. 30, 2026) Meanwhile, in all the aspects of the inventive concept, there is no property interest in the government of the Republic of Korea.

### CROSS-REFERENCE TO RELATED APPLICATION

This application claims the benefit of and priority to Korean Patent Application No. 10-2024-0086592, filed on Jul. 2, 2024, and Korean Patent Application No. 10-2024-0096476, filed on Jul. 22, 2024, the entire disclosure(s) of which is hereby incorporated herein by reference in its entirety.

### TECHNICAL FIELD

The present disclosure relates to a semiconductor system and a method of controlling a reset operation clock thereof, and more specifically, to a semiconductor system and a method of controlling a reset operation clock thereof for easily setting a reset timing for flip-flops in the power domain by inputting a reference clock operating slower than a function clock to a clock operation unit through a clock multiplexer during a reset operation or reset release operation.

### BACKGROUND

In general, in a hardware circuit, there is a constraint that the reset operation or reset release operation of all flip-flops in the power domain must be performed within the same clock cycle. This is because when multiple flip-flops in the power domain are reset or resetting is released at different clock cycles, an error may occur in the reset operation or reset release operation.

There are numerous flip-flops in the power domain, and in the case of hardware that operates with a very high-frequency clock, it becomes very difficult to determine the timing of the reset tree. Additionally, in order to set a timing such that reset operations or reset release operations of all flip-flops within the power domain will be performed within the same clock cycle, a large number of buffers are required for the reset tree in semiconductor design, which inevitably increases the circuit area of the semiconductor system.

### SUMMARY

In view of the above, the present disclosure provides a semiconductor system and a method of controlling a reset operation clock of the semiconductor system, which can easily set a reset timing for flip-flops in the power domain by inputting a reset reference clock or a reset release reference clock, which is slower than a function clock, to a clock operation unit by a clock multiplexer during a reset operation or reset release operation.

The aspects to be achieved by embodiments of the present disclosure are not limited to the aspects described above, and other aspects can be inferred from the following embodiments.

A semiconductor system according to an aspect of the present disclosure includes a clock management unit configured to operate according to a function clock to generate and output an output function clock for an operation of the semiconductor system, and a power management unit configured to perform power management of the semiconductor system including a reset operation or a reset release operation.

The clock management unit includes a clock operation unit configured to operate according to the function clock in an operation mode to generate and output the output function clock, and a clock multiplexer configured to select different input clocks to be input to the clock operation unit in the operation mode and a reset mode and output the input clocks to the clock operation unit.

The clock multiplexer may select the function clock and input the function clock to the clock operation unit in the operation mode, and select a reference clock for the reset operation or the reset release operation and output the reference clock to the clock operation unit in the reset mode.

The reference clock may be a clock operating slower than the function clock such that flip-flops within a power domain are reset or reset of the flip-flops is released within the same clock cycle.

The reference clock may be a clock operating at least three times slower than the function clock.

An output reset clock output from the clock operation unit in the reset mode may be a clock having a lower frequency than the output function clock.

The power management unit may output a reset operation signal to the clock management unit during a reset operation for the power domain, and output a reset release operation signal to the clock management unit during a reset release operation for the power domain.

The clock multiplexer may select a reference clock for the reset operation or the reset release operation according to at least one of the reset operation signal or the reset release operation signal and output the reference clock to the clock operation unit.

The clock multiplexer may select a reset reference clock from among the reset reference clock and a reset release reference clock according to the reset operation signal, output the reset reference clock to the clock operation unit, select the reset release reference clock according to the reset release operation signal, and output the reset release reference clock to the clock operation unit.

The clock multiplexer may receive one or more function clocks and a plurality of reference clocks having different clock frequencies, select one of the plurality of reference clocks according to the reset operation signal or the reset release operation signal, and output the selected reference clock to the clock operation unit.

The semiconductor system may further include a controller configured to control the clock multiplexer. The controller may control the clock multiplexer such that the input clock for the clock operation unit is not changed to the reference clock at the time of switching to the reset mode, and the function clock is input to the clock operation unit when it is determined that a cycle of the output function clock output by the clock operation unit in the operation mode is equal to or greater than a reference cycle set in relation to a reset timing or that a frequency of the output function clock is equal to or less than a reference frequency set in relation to the reset timing.

According to an aspect of the present disclosure, a clock management unit configured to operate according to a function clock and generate and output an output function clock for an operation of a semiconductor system includes a clock operation unit configured to operate according to the function clock to generate and output the output function clock in an operation mode, and a clock multiplexer configured to select a reference clock from among the function clock and the reference clock in a reset mode in which a reset operation signal or a reset release operation signal is input from a power management unit and to input the reference clock to the clock operation unit.

A method of controlling a reset operation clock of a semiconductor system according to an aspect of the present disclosure includes generating and outputting, by a clock operation unit of a clock management unit, an output function clock for an operation of the semiconductor system according to a function clock in an operation mode, performing, by a power management unit, power management of the semiconductor system including a reset operation or a reset release operation, and selecting a reference clock and outputting the reference clock to the clock operation unit, by a clock multiplexer of the clock management unit, in a reset mode for a reset operation or a reset release operation.

The clock multiplexer may select the function clock from among the function clock and the reference clock and input the function clock to the clock operation unit in the outputting the function clock, and the clock multiplexer may select the reference clock from among the function clock and the reference clock and output the reference clock to the clock operation unit in the outputting the reference clock.

The performing power management may include outputting a reset operation signal to the clock management unit during a reset operation for the power domain, and outputting a reset release operation signal to the clock management unit during a reset release operation for the power domain.

The outputting the reference clock may include selecting a reference clock for a reset operation or a reset release operation according to at least one of the reset operation signal or the reset release operation signal and outputting the reference clock to the clock operation unit. The outputting the reference clock may include selecting a reset reference clock from among the reset reference clock and a reset release reference clock according to the reset operation signal and outputting the reset reference clock to the clock operation unit, and selecting the reset release reference clock according to the reset release operation signal and outputting the reset release reference clock to the clock operation unit.

The outputting the reference clock may include receiving one or more function clocks and a plurality of reference clocks having different clock frequencies, selecting one of the plurality of reference clocks according to the reset operation signal or the reset release operation signal, and outputting the selected reference clock to the clock operation unit.

The method may further include controlling the clock multiplexer by a controller such that the input clock for the clock operation unit is not changed to the reference clock at the time of switching to the reset mode, and the function clock is input to the clock operation unit when it is determined that a cycle of the output function clock output by the clock operation unit in the operation mode is equal to or greater than a reference cycle set in relation to a reset timing or that a frequency of the output function clock is equal to or less than a reference frequency set in relation to the reset timing.

According to an aspect of the present disclosure, there is provided a computer-readable recording medium storing a computer program for executing the method of controlling a reset operation clock of a semiconductor system.

### Advantageous Effects

According to embodiments of the present disclosure, it is possible to provide a semiconductor system and a method of controlling a reset operation clock thereof, which can easily set a reset timing for flip-flops in the power domain by inputting a reset reference clock or a reset release reference clock, which is slower than a function clock, to a clock operation unit by a clock multiplexer during a reset operation or reset release operation.

### BRIEF DESCRIPTION OF THE DRAWINGS

FIG. 1 is a configuration diagram of a semiconductor system according to an embodiment of the present disclosure.

FIG. 2 is a flowchart of a method of controlling a reset operation clock of the semiconductor system according to an embodiment of the present disclosure.

FIG. 3 is a diagram illustrating the operation of the semiconductor system and the effect of the reset operation clock control method according to an embodiment of the present disclosure.

FIG. 4A is a flowchart showing a method of controlling a reset operation clock of the semiconductor system according to another embodiment of the present disclosure.

FIG. 4B is a diagram showing a case in which a clock divider divides a clock input by 8 to generate a clock output.

FIG. 5 is a conceptual diagram showing a computing device for executing a reset operation clock control method according to an embodiment of the present disclosure.

### DETAILED DESCRIPTION

Hereinafter, specific details for implementing the present disclosure will be described in detail with reference to the attached drawings. However, in the following description, a detailed description of known functions and configurations incorporated herein will be omitted when it may obscure the subject matter of the present disclosure. In the attached drawings, the same reference numbers will be used to refer to the same or like parts. In the description of the embodiments below, redundant descriptions of identical or corresponding components may be omitted. However, even if descriptions of components are omitted, it is not intended that such components are not included in any embodiment.

The advantages and features of the embodiments disclosed in this specification, and the methods for achieving the same will become clear with reference to the embodiments described below together with the attached drawings. However, the present disclosure is not limited to the embodiments disclosed below, but may be implemented in various different forms, and the embodiments are only provided to fully inform those skilled in the art of the scope of the present disclosure.

The terms used in this specification will be briefly explained, and the disclosed embodiments will be described in detail. The terms used in this specification are selected from the most widely used general terms possible while considering the functions of the present disclosure, but they may vary depending on the intention of engineers working in the relevant field, precedents, or the emergence of new technologies. In addition, in certain cases, there are terms arbitrarily selected by the applicant, and in this case, the meanings thereof will be described in detail in the description of the disclosure. Therefore, the terms used in the present disclosure should be defined based on the meanings of the terms and the overall contents of the present disclosure, rather than simply the names of the terms.

In this specification, singular expressions include plural expressions unless the context clearly specifies that they are singular. In addition, plural expressions include singular expressions unless the context clearly specifies that they are plural. When a part of the specification is said to include a certain component, this does not mean that other components are excluded, but rather that other components may be included, unless otherwise specifically stated. In the present disclosure, the terms “comprise” “comprising”, and the like may indicate that features, steps, operations, elements, and/or components are present, and these terms do not exclude the addition of one or more other functions, steps, operations, elements, components, and/or combinations thereof.

In the present disclosure, when a particular component is referred to as being “coupled to”, “combined with,” “connected to”, “associated with”, or “reacted with” another particular component, the particular component may be directly coupled to, combined with, connected to, associated with, or reacted with the other component, but is not limited thereto. For example, one or more intermediate components may be present between the particular component and the other component. Additionally, in the present disclosure, “and/or” may include each of one or more of listed items, or a combination of at least some of listed items. In the present disclosure, the terms “first”, “second”, etc. are used to distinguish a specific component from other components, and the components described above are not limited by these terms. For example, the “first” component may be used to refer to an element of the same or similar form as the “second” component.

A semiconductor system and a reset operation clock control method of the semiconductor system according to an embodiment of the present disclosure are characterized in that a reset timing can be easily set for flip-flops in the power domain by selecting a function clock and inputting the same to a clock operation unit in an operation mode, and selecting a reference clock slower than the function clock and inputting the same to the clock operation unit in a reset mode using a clock multiplexer.

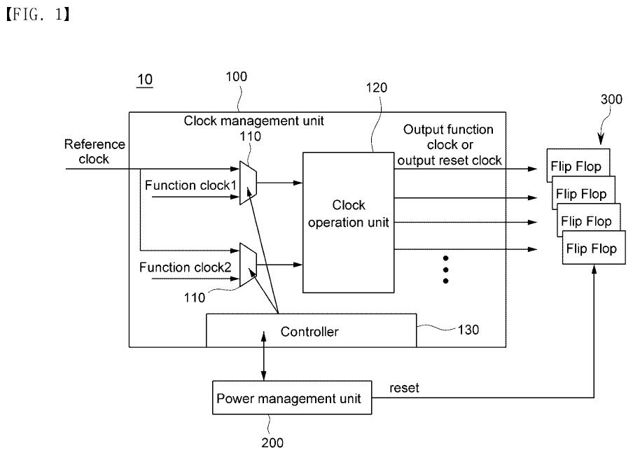

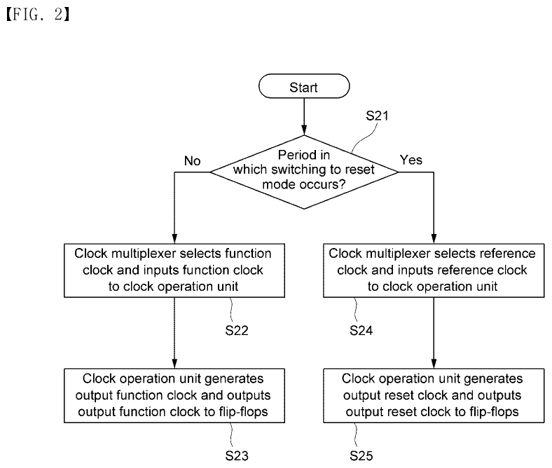

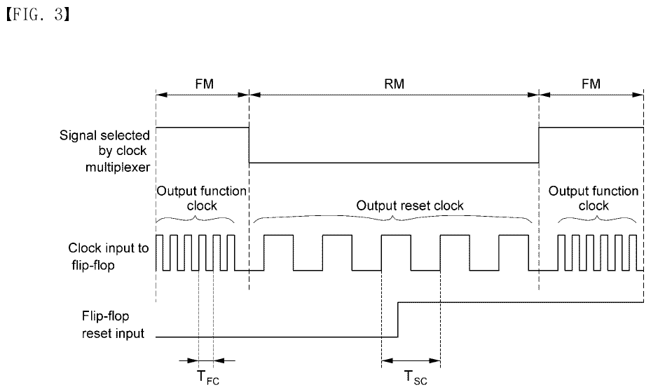

FIG. 1 is a configuration diagram of a semiconductor system according to an embodiment of the present disclosure. FIG. 2 is a flowchart of a reset operation clock control method of the semiconductor system according to an embodiment of the present disclosure. FIG. 3 is a diagram illustrating the operation of the semiconductor system and the effect of the reset operation clock control method according to the embodiment of the present disclosure. Referring to FIGS. 1 to 3, the semiconductor system 10 according to the embodiment of the present disclosure may include a clock management unit 100, a power management unit 200, and a plurality of flip-flops 300.

The clock management unit 100 may operate according to a function clock to generate and output an output function clock for the operation of the semiconductor system 10. The clock management unit 100 may include a number of clock components. The clock components may include, but are not limited to, a PLL controller component, a clock divider component, a clock multiplexer component, a clock gate component, etc.

The clock management unit 100 may generate one or more output function clocks and provide the same to a number of IP blocks. The IP blocks are connected to a system bus and may communicate with each other through the system bus. The IP blocks may include a processor, a graphic processor, a memory controller, an input/output interface block, etc.

The power management unit 200 can control the power supplied to the IP blocks. For example, when the system on chip enters a standby mode, the power management unit 200 can cut off power supply to each IP block, thereby reducing the power consumption of the system on chip. The power management unit 200 may perform power management of the semiconductor system 10 including a reset operation or a reset release operation.

The clock management unit 100 may include a clock multiplexer 110 and a clock operation unit 120. The clock multiplexer 110 may select different input clocks to be input to the clock operation unit 120 in the operation mode and the reset mode and output the same to the clock operation unit 120. The clock multiplexer 110 may select a function clock in the operation mode (function mode) (FM) and input the same to the clock operation unit 120, and select a reference clock, which is a reset clock, in the reset mode (RM) and input the same to the clock operation unit 120.

The function clock may be a clock having a frequency/cycle that is optimally designed in advance for performing a set operation of the clock operation unit 120 in an operation mode other than the reset mode. The function clock may be set for each clock operation unit 120 of the clock management unit 100, or may be set identically for a plurality of clock operation units 120. Alternatively, the function clock may be set identically for all clock operation units 120 within the power domain.

The reference clock may be set as a clock having a lower frequency than the function clock of each clock operation unit 120. The reference clock may be input to the clock operation unit 120 only during the reset mode, and may not be input to the clock operation unit 120 in an operation mode other than the reset mode. Similarly to the function clock, the reference clock may be set individually for each clock operation unit 120, may be set identically for the plurality of clock operation units 120, or may be set identically for all clock operation units 120 within the power domain.

The clock operation unit 120 may operate according to the function clock in the operation mode (FM) to generate an output function clock and input the output function clock to the flip-flops 300 of the IP blocks in the power domain. The clock operation unit 120 may operate according to the reference clock in the reset mode (RM) to generate an output reset clock and input the output reset clock to the flip-flops 300 of the IP blocks in the power domain.

The power management unit 200 may output a reset operation signal to a controller 130 of the clock management unit 100 during a reset operation for the power domain. In addition, the power management unit 200 may output a reset release operation signal to the controller 130 of the clock management unit 100 during a reset release operation for the power domain. The controller 130 may control the clock multiplexer 110 according to the reset operation signal and/or the reset release operation signal received from the power management unit 200.

The controller 130 of the clock management unit 100 may include a register. Information necessary for controlling and setting the operation of the clock management unit 100 may be recorded in the register of the controller 130. The controller 130 may receive the reset operation signal and/or the reset release operation signal from the power management unit 200 and output selection signals corresponding to the reset operation signal and/or the reset release operation signal to the clock multiplexer 110.

The controller 130 may determine whether the operation is in a period in which transition to the reset mode occurs according to the reset operation signal and/or the reset operation release signal received from the power management unit 200 (step S21 in FIG. 2). The clock multiplexer 110 may select an input clock input to the clock operation unit 110 according to a selection signal of the controller 130. If the operation is not in a period in which transition to the reset mode occurs, the controller 130 may output a first selection signal (e.g., a first logic signal of “0” or “1”) for selecting the function clock to the clock multiplexer 110.

The clock multiplexer 110 may select the function clock in the operation mode (FM) according to the first selection signal received from the controller 130 and input the function clock to the clock operation unit 120 (step S22 in FIG. 2). The clock operation unit 120 may generate an output function clock according to the function clock selected and input by the clock multiplexer 110 in the operation mode (function mode) (FM) and output the same to the flip-flops 300 in the power domain (step S23 in FIG. 2).

If the operation is in a period in which transition to the reset mode occurs, the controller 130 may output a second selection signal (for example, a second logic signal of “1” or “0”) for selecting a reference clock for reset or reset release (a slow clock for reset operation or reset release operation) to the clock multiplexer 110. The second selection signal may be a logic signal that is distinguished from the first selection signal.

The clock multiplexer 110 may select a reference clock in the reset mode (RM) according to the second selection signal received from the controller 130 and input the same to the clock operation unit 120 (step S24 in FIG. 2). The clock operation unit 120 may generate an output reset clock according to the reference clock selected and input by the clock multiplexer 110 in the reset mode (RM) and output the same to the flip-flops 300 in the power domain (step S25 in FIG. 2).

The reference clock may be a clock that operates much slower than the function clock such that the flip-flops in the power domain can be reset or reset of the flip-flops is released within the same clock cycle. That is, the output reset clock output from the clock operation unit 120 in the reset mode (RM) may be a clock having a lower frequency than the output function clock. Preferably, the reference clock may be a clock that operates at least three times slower than the function clock. In other words, the reference clock may be a clock that is at least three times slower than the function clock, more preferably at least five times or at least ten times slower than the function clock, such that the clock cycle T_{SC} of the output reset clock is much longer than the clock cycle T_{FC} of the output function clock.

As described above, the clock multiplexer 110 may select a reference clock for a reset operation or a reset release operation according to at least one of the reset operation signal or the reset release operation signal and output the same to the clock operation unit 120. In an embodiment, the clock multiplexer 110 may select a reset reference clock from among the reset reference clock and a reset release reference clock according to the reset operation signal and output the same to the clock operation unit 120, and may select a reset release reference clock according to the reset release operation signal and output the same to the clock operation unit 120.

In an embodiment, the reset reference clock and the reset release reference clock may be the same clock having the same frequency/cycle. In another embodiment, the reset reference clock and the reset release reference clock may be provided as clocks having different frequencies/cycles. In this case, both the reset reference clock and the reset release reference clock may be set to clocks slower than the function clock (a low-frequency clock).

The clock multiplexer 110 may receive one or more function clocks and a plurality of reference clocks having different clock frequencies, select one of the plurality of reference clocks according to the reset operation signal or the reset release operation signal, and output the same to the clock operation unit. In this case, the controller 130 may output a selection signal of 2 bits or more to the clock multiplexer 110 according to the reset operation signal or the reset release operation signal received from the power management unit 200 to select one of the plurality of reference clocks.

According to the semiconductor system and the reset operation clock control method thereof according to the embodiment of the present disclosure as described above, by lowering the frequency of the input clock input to the clock operation unit and inputting a reference clock of a low frequency to the clock operation unit, the reset operations and/or the reset release operations of all flip-flops in the power domain can be performed within the same cycle, thereby preventing malfunction during the reset or reset release operation.

In addition, according to the embodiment of the present disclosure, it is possible to easily set a reset timing or reset release timing of flip-flops in the power domain within an extended clock cycle T_{SC} of the output reset clock using a slowly operating reference clock, to reduce the number of buffer cells for setting the reset timing or reset release timing of numerous flip-flops, and to decrease the difficulty of physical implementation, thereby reducing the overall area and manufacturing cost of the semiconductor system.

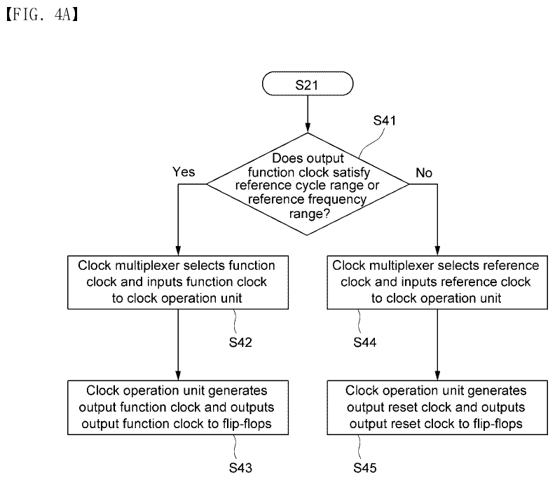

FIG. 4A is a flowchart showing a reset operation clock control method of the semiconductor system according to another embodiment of the present disclosure. In another embodiment of the present disclosure, the controller 130 may not input the reference clock to all clock operation units 120 of the clock management unit 100 in the reset mode, but may select only some clock operation units 120 such that the reference clock is input instead of the function clock only to the selected clock operation units 120.

For example, if the operation is in a period in which transition to the reset mode occurs (S21), the controller 130 may determine whether to switch the input clock for the clock operation units 120 by determining whether the cycle of the output function clock output by each clock operation unit 120 in the operation mode (function mode) is equal to or greater than a reference cycle set in relation to a reset timing, or whether the frequency of the output function clock is equal to or less than a reference frequency set in relation to the reset timing (S41).

If the controller 130 determines that the cycle of the output function clock output by each clock operation unit 120 in the operation mode (function mode) is equal to or greater than the reference period set in relation to the reset timing (or that the frequency of the output function clock is equal to or less than the reference frequency set in relation to the reset timing), i.e., if the output function clock is determined to satisfy the reference cycle range or reference frequency range, the input clock for the clock operation unit 120 may not be changed to the reference clock (S42 and S43). Accordingly, transmission of an unnecessary selection signal can be prevented, and the operation of the semiconductor system can be efficiently controlled.

FIG. 4B is a diagram showing a case in which a clock divider divides a clock input by 8 to generates a clock output. For example, if the divide value of the clock divider is 8, an output clock divided by 8 from the input clock can be output by the clock divider. In this case, the output clock of the clock divider becomes a clock signal having a cycle 8 times that of the input clock (a clock signal having a frequency of ⅛ of the input clock). At this time, the clock divider counts the input clocks through a counter and generates rising or falling edges based on the count value of the counter to generate output clocks.

Unlike the example shown in FIG. 4B, if the divide value of the clock divider is 2, an output clock divided by 2 from the input clock can be output by the clock divider. In this case, the output clock of the clock divider becomes a clock signal having a cycle twice that of the input clock (a clock signal having a frequency of ½ of the input clock). Accordingly, the output clock of the clock divider when the divide value is 2 has a shorter cycle (higher frequency) than the output clock when the divide value is 8.

For example, when the clock operation unit 120 corresponds to a clock divider, the controller 130 may compare the cycle or frequency of the output function clock of the clock operation unit 120 with the reference cycle or reference frequency based on the divide value set for the clock divider. For example, when the divide value input to the clock divider is equal to or greater than a reference divide value (e.g., 8), the controller 130 determines that the cycle or frequency of the output function clock satisfies the reference cycle range or reference frequency range set in relation to the reset timing, and thus can maintain the input clock of the clock divider as the function clock without outputting a selection signal for switching the input clock to the reference clock for the clock divider.

On the other hand, if the divide value set for the clock divider is less than the reference divide value (for example, if the divide value of the clock divider is less than 8), the controller 130 determines that the cycle or frequency of the output function clock does not satisfy the reference cycle range or reference frequency range set in relation to the reset timing, and thus may output a selection signal for switching the input clock for the clock divider to a reference clock having a low frequency (long cycle) to the clock multiplexer 110 corresponding to the clock divider in order to secure a stable reset timing (S44 and S45).

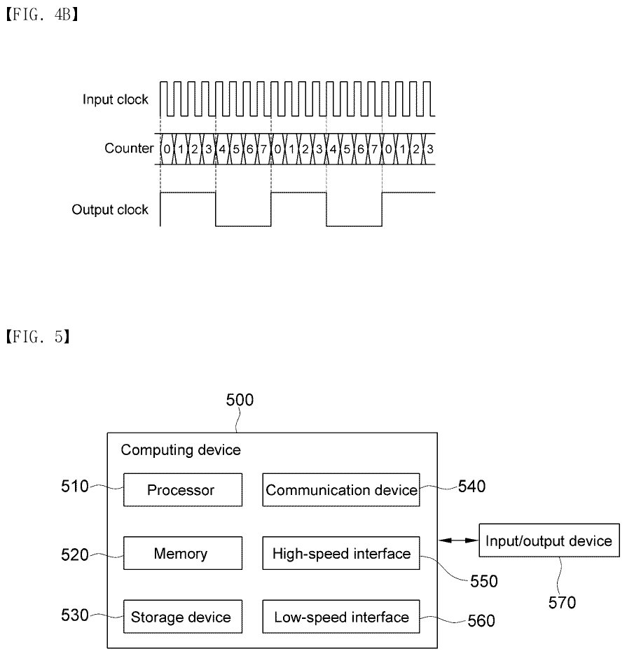

FIG. 5 is a conceptual diagram illustrating a computing device for executing a reset operation clock control method according to an embodiment of the present disclosure. An exemplary computing device 500 for performing the above-described method and/or embodiment will be described. According to one embodiment, the computing device 500 may be implemented using hardware and/or software configured to interact with a user. The computing device 500 may include, but is not limited to, a laptop, a desktop, a workstation, a personal digital assistant, a server, a blade server, a main frame, etc. The components of the computing device described above, the connection relationships thereof, and functions thereof are intended to be exemplary and are not intended to limit the implementations of the present disclosure described and/or claimed herein.

The computing device 500 includes a processor 510, a memory 520, a storage device 530, a communication device 540, a high-speed interface 550 connected to the memory 520 and a high-speed expansion port, and a low-speed interface 560 connected to a low-speed bus and the storage device. The components 510, 520, 530, 540, 550, and 560 may be interconnected using various buses and may be mounted on the same main board or may be mounted and connected in another suitable manner. The processor 510 may be configured to process instructions of a computer program by performing basic arithmetic, logic, and input/output operations. For example, the processor 510 may process instructions stored in the memory 520 and the storage device 530 and/or instructions executed within the computing device 500, and display graphic information on an external input/output device 570, such as a display device, coupled to the high-speed interface 550.

The communication device 540 may provide a configuration or function for the input/output device 570 and the computing device 500 to communicate with each other through a network, and may provide a configuration or function for supporting the input/output device 570 and/or the computing device 500 to communicate with other external devices. For example, a request or data generated by a processor of an external device according to any program code may be transmitted to the computing device 500 through a network under the control of the communication device 540. Conversely, a control signal or command provided under the control of the processor 510 of the computing device 500 may be transmitted to another external device through the communication device 540 and a network.

Although the computing device 500 is illustrated as including one processor 510, one memory 520, etc., the present disclosure is not limited thereto, and the computing device 500 may be implemented using multiple memories, multiple processors, and/or multiple buses, etc. In addition, although one computing device 500 is illustrated, the present disclosure is not limited thereto, and multiple computing devices may interact and perform operations necessary to execute the method described above.

The memory 520 may store information within the computing device 500. According to an embodiment, the memory 520 may be composed of a volatile memory unit or multiple memory units. Additionally or alternatively, the memory 520 may be composed of a non-volatile memory unit or multiple memory units. In addition, the memory 520 may be configured as a computer-readable medium, such as a magnetic disk or an optical disc. In addition, the memory 520 may store an operating system and at least one program code and/or instruction.

The storage device 530 may be one or more large-capacity storage devices for storing data for the computing device 500. For example, the storage device 530 may be a computer-readable medium including, or configured to include, a magnetic disk such as a hard disk, a removable disk, an optical disc, a semiconductor memory device such as an erasable programmable read-only memory (EPROM), an electrically erasable PROM (EEPROM), a flash memory device, a CD-ROM, and a DVD-ROM disk. In addition, a computer program may be tangibly implemented in such a computer-readable medium.

The high-speed interface 550 and the low-speed interface 560 may be means for interacting with the input/output device 570. For example, the input device may include devices such as a camera including an audio sensor and an image sensor, a keyboard, a microphone, and a mouse, and the output device may include devices such as a display, a speaker, and a haptic feedback device. In another example, the high-speed interface 550 and the low-speed interface 560 may be means for interfacing with a device in which components and functions for performing input and output are integrated, such as a touchscreen.

In an embodiment, the high-speed interface 550 may manage bandwidth-intensive operations with respect to the computing device 500, whereas the low-speed interface 560 may manage less bandwidth-intensive operations than the high-speed interface 550, but such functional allocation is merely exemplary. In an embodiment, the high-speed interface 550 may be coupled to the memory 520, the input/output device 570, and high-speed expansion ports that may accommodate various expansion cards (not shown). Additionally, the low-speed interface 560 may be coupled to the storage device 530 and a low-speed expansion port. Additionally, the low-speed expansion port, which may include various communication ports (e.g., USB, Bluetooth, Ethernet, and wireless Ethernet), may be coupled to one or more input/output devices 570, such as a keyboard, a pointing device, and a scanner, or a networking device, such as a router or a switch via a network adapter.

The computing device 500 may be implemented in a number of different forms. For example, the computing device 500 may be implemented as a standard server, or may be implemented as a group of such standard servers. Additionally or alternatively, the computing device 500 may be implemented as part of a rack server system, or may be implemented as a personal computer, such as a laptop computer. In this case, components of the computing device 500 may be combined with other components within any mobile device (not shown). The computing device 500 may include one or more other computing devices, or may be configured to communicate with one or more other computing devices.

Although the input/output device 570 is illustrated as not being included in the computing device 500, the present disclosure is not limited thereto, and the input/output device 570 may be integrated with the computing device 500. In addition, although the high-speed interface 550 and/or the low-speed interface 560 are illustrated as elements configured separately from the processor 510, the present disclosure is not limited thereto, and the high-speed interface 550 and/or the low-speed interface 560 may be configured to be included in the processor 510.

The above-described methods and/or various embodiments may be realized by digital electronic circuits, computer hardware, firmware, software, and/or a combination thereof. The various embodiments of the present disclosure may be executed by a data processing device, for example, one or more programmable processors and/or one or more computing devices, or implemented as a computer-readable medium and/or a computer program stored in a computer-readable medium. The above-described computer program may be written in any form of programming language, including compiled or interpreted languages, and may be distributed in any form, such as a standalone program, a module, and a subroutine. The computer program may be distributed through a single computing device, multiple computing devices connected through the same network, and/or multiple computing devices distributed to be connected through multiple different networks.

The above-described methods and/or various embodiments may be performed by one or more processors configured to execute one or more computer programs that process, store, and/or manage any function, etc. by operating based on input data or generating output data. For example, the methods and/or various embodiments of the present disclosure may be performed by a special purpose logic circuit such as a field programmable gate array (FPGA) or an application specific integrated circuit (ASIC), and a device and/or a system for performing the methods and/or embodiments of the present disclosure may be implemented as a special purpose logic circuit such as an FPGA or an ASIC.

The one or more processors executing the computer program may include a general purpose or special purpose microprocessor and/or one or more processors of any kind of digital computing device. The processor may receive instructions and/or data from each of a read-only memory and a random access memory, or may receive instructions and/or data from the read-only memory and the random access memory. In the present disclosure, the components of the computing device performing the methods and/or embodiments may include one or more processors for executing instructions, and one or more memories for storing instructions and/or data.

According to an embodiment, the computing device may transmit/receive data to/from one or more large-capacity storage devices for storing data. For example, the computing device may receive data from a magnetic disk or an optical disc and transmit data thereto. A computer-readable medium suitable for storing instructions and/or data associated with a computer program may include, but is not limited to, any form of non-volatile memory, including semiconductor memory devices such as an erasable programmable read-only memory (EPROM), an electrically erasable PROM (EEPROM), and a flash memory device. For example, the computer-readable medium may include a magnetic disk, such as an internal hard disk or a removable disk, a photomagnetic disc, a CD-ROM, and a DVD-ROM disc.

To provide interaction with a user, the computing device may include, but is not limited to, a display device (e.g., a cathode ray tube (CRT), a liquid crystal display (LCD), or the like) for providing or displaying information to the user, and a pointing device (e.g., a keyboard, a mouse, a trackball, or the like) for enabling the user to provide input and/or commands to the computing device. That is, the computing device may further include any other types of devices for providing interaction with the user. For example, the computing device may provide any form of sensory feedback, including visual feedback, auditory feedback, and/or tactile feedback, to the user for interacting with the user. In this regard, the user may provide input to the computing device through various gestures, such as sight, voice, and motion.

In the present disclosure, various embodiments may be implemented in a computing device including a back-end component (e.g., a data server), a middleware component (e.g., an application server), and/or a front-end component. In this case, the components may be interconnected by any form or medium of digital data communication, such as a communication network. According to an embodiment, the communication network may be a wired network such as Ethernet, a wired home network (Power Line Communication), a telephone line communication device, or RS-serial communication, a wireless network such as a mobile communication network, a wireless LAN (WLAN), Wi-Fi, Bluetooth, or ZigBee, or a combination thereof. For example, the communication network may include a local area network (LAN), a wide area network (WAN), etc.

The computing device based on the exemplary embodiments described herein may be implemented using hardware and/or software configured to interact with a user, including a user device, a user interface (UI) device, a user terminal, or a client device. For example, the computing device may include a portable computing device such as a laptop computer. Additionally or alternatively, the computing device may include, but is not limited to, a personal digital assistant (PDA), a tablet computer, a game console, a wearable device, an IoT (Internet of Things) device, a virtual reality (VR) device, an augmented reality (AR) device, and the like. The computing device may further include other types of devices configured to interact with a user. Furthermore, the computing device may include a portable communication device (e.g., a mobile phone, a smartphone, a wireless cellular phone, and the like) suitable for wireless communication over a network, such as a mobile communication network. The computing device may be configured to wirelessly communicate with a network server using wireless communication technologies and/or protocols, such as Radio Frequency (RF), Microwave Frequency (MWF), and/or Infrared Ray Frequency (IRF).

The various embodiments including specific structural and functional details in the present disclosure are exemplary. Therefore, the embodiments of the present disclosure are not limited to those described above, and may be implemented in various other forms. In addition, the terms used in the present disclosure are intended to describe some embodiments and are not to be construed as limiting the embodiments. For example, singular words may be construed to include plural forms unless the context clearly indicates otherwise.

In the present disclosure, unless otherwise defined, all terms used in this specification, including technical or scientific terms, have the same meaning as commonly understood by a person skilled in the art to which such concepts belong. In addition, commonly used terms, such as terms defined in dictionaries, should be interpreted as having meanings consistent with the meanings in the context of the relevant technology.

Although the present disclosure has been described in connection with some embodiments herein, various modifications and changes may be made without departing from the scope of the present disclosure as understood by a person skilled in the art to which the present disclosure belongs. In addition, such modifications and changes should be considered to fall within the scope of the claims appended hereto.

### DETAILED DESCRIPTION OF MAIN ELEMENTS

10: semiconductor system
100: clock management unit
110: clock multiplexer
120: clock operation unit
130: controller
200: power management unit
300: flip-flop
500: computing device
510: processor
520: memory
530: storage device
540: communication device
550: high-speed interface
560: low-speed interface
570: external input/output device

What is claimed is:

1. A semiconductor system comprising:
a clock management unit configured to operate according to a function clock to generate and output an output function clock for an operation of the semiconductor system; and
a power management unit configured to perform power management of the semiconductor system including a reset operation or a reset release operation,
wherein the clock management unit comprises:
a clock operation unit configured to operate according to the function clock in an operation mode to generate and output the output function clock; and
a clock multiplexer configured to select different input clocks to be input to the clock operation unit in the operation mode and a reset mode and output the input clocks to the clock operation unit.

2. The semiconductor system of claim 1, wherein the clock multiplexer selects the function clock and inputs the function clock to the clock operation unit in the operation mode, and selects a reference clock for the reset operation or the reset release operation and outputs the reference clock to the clock operation unit in the reset mode.

3. The semiconductor system of claim 2, wherein the reference clock is a clock operating slower than the function clock such that flip-flops within a power domain are reset or reset of the flip-flops is released within the same clock cycle.

4. The semiconductor system of claim 3, wherein the reference clock is a clock operating at least three times slower than the function clock.

5. The semiconductor system of claim 1, wherein an output reset clock output from the clock operation unit in the reset mode is a clock having a lower frequency than the output function clock.

6. The semiconductor system of claim 1, wherein the power management unit outputs a reset operation signal to the clock management unit during a reset operation for the power domain, and outputs a reset release operation signal to the clock management unit during a reset release operation for the power domain.

7. The semiconductor system of claim 6, wherein the clock multiplexer selects a reset reference clock from among the reset reference clock and a reset release reference clock according to the reset operation signal, outputs the reset reference clock to the clock operation unit, selects the reset release reference clock according to the reset release operation signal, and outputs the reset release reference clock to the clock operation unit.

8. The semiconductor system of claim 7, wherein the clock multiplexer receives one or more function clocks and a plurality of reference clocks having different clock frequencies, selects one of the plurality of reference clocks according to the reset operation signal or the reset release operation signal, and outputs the selected reference clock to the clock operation unit.

9. The semiconductor system of claim 2, further comprising a controller configured to control the clock multiplexer,
wherein the controller controls the clock multiplexer such that the input clock for the clock operation unit is not changed to the reference clock at the time of switching to the reset mode, and the function clock is input to the clock operation unit when it is determined that a cycle of the output function clock output by the clock operation unit in the operation mode is equal to or greater than a reference cycle set in relation to a reset timing or that a frequency of the output function clock is equal to or less than a reference frequency set in relation to the reset timing.

10. A clock management unit configured to operate according to a function clock and generate and output an output function clock for an operation of a semiconductor system, the clock management unit comprising:
a clock operation unit configured to operate according to the function clock to generate and output the output function clock in an operation mode; and
a clock multiplexer configured to select a reference clock from among the function clock and the reference clock in a reset mode in which a reset operation signal or a reset release operation signal is input from a power management unit and to input the reference clock to the clock operation unit,
wherein the reference clock is a clock operating slower than the function clock such that flip-flops in a power domain are reset or reset of the flip-flops is released within the same clock cycle.

11. A non-transitory computer-readable recording medium storing a computer program for executing a method of controlling a reset operation clock of a semiconductor system, wherein the method comprises:
generating and outputting, by a clock operation unit of a clock management unit, an output function clock for an operation of the semiconductor system according to a function clock in an operation mode;
performing, by a power management unit, power management of the semiconductor system including a reset operation or a reset release operation; and
selecting a reference clock and outputting the reference clock to the clock operation unit, by a clock multiplexer of the clock management unit, in a reset mode for a reset operation or a reset release operation.

12. The non-transitory computer-readable recording medium of claim 11, wherein the clock multiplexer selects the function clock from among the function clock and the reference clock and inputs the function clock to the clock operation unit in the outputting the function clock, and the clock multiplexer selects the reference clock from among the function clock and the reference clock and outputs the reference clock to the clock operation unit in the outputting the reference clock.

13. The non-transitory computer-readable recording medium of claim 12, wherein the reference clock is a clock operating slower than the function clock such that flip-flops in a power domain are reset or reset of the flip-flops is released within the same clock cycle.

14. The non-transitory computer-readable recording medium of claim 13, wherein the reference clock is a clock operating at least three times slower than the function clock.

15. The non-transitory computer-readable recording medium of claim 11, wherein an output reset clock output from the clock operation unit in the reset mode is a clock having a lower frequency than the output function clock.

16. The non-transitory computer-readable recording medium of claim 11, wherein the performing power management comprises:
outputting a reset operation signal to the clock management unit during a reset operation for a power domain; and
outputting a reset release operation signal to the clock management unit during a reset release operation for the power domain.

17. The non-transitory computer-readable recording medium of claim 16, wherein the outputting the reference clock comprises:
selecting a reset reference clock from among the reset reference clock and a reset release reference clock according to the reset operation signal and outputting the reset reference clock to the clock operation unit; and
selecting the reset release reference clock according to the reset release operation signal and outputting the reset release reference clock to the clock operation unit.

18. The non-transitory computer-readable recording medium of claim 17, wherein the outputting the reference clock comprises receiving one or more function clocks and a plurality of reference clocks having different clock frequencies, selecting one of the plurality of reference clocks according to the reset operation signal or the reset release operation signal, and outputting the selected reference clock to the clock operation unit.

19. The non-transitory computer-readable recording medium of claim 11, wherein the method further comprises:
controlling the clock multiplexer by a controller such that an input clock for the clock operation unit is not changed to the reference clock at the time of switching to the reset mode, and the function clock is input to the clock operation unit when it is determined that a cycle of the output function clock output by the clock operation unit in the operation mode is equal to or greater than a reference cycle set in relation to a reset timing or that a frequency of the output function clock is equal to or less than a reference frequency set in relation to the reset timing.
